(19) United States
(12) Patent Application Publication
(10) Pub. No.: US 2011/0001603 A1
(43) Pub. Date: Jan. 6, 2011

(54) METHODS AND APPARATUS RELATING TO A SECURITY SYSTEM

(76) Inventor: Nicholas Hedley Willis, Auckland (NZ)

Correspondence Address: THE LAW OFFICES OF BRADLEY J. BEREZNAK, 800 WEST EL CAMINO REAL, SUITE 180, MOUNTAIN VIEW, CA, 94040, US

(21) Appl. No.: 12/747,259

(22) PCT Filed: Nov. 27, 2008
(86) PCT No.: PCT/NZ08/00319

§ 371 Date: Sep. 13, 2010

(30) Foreign Application Priority Data
Dec. 10, 2007 (NZ) 564196

(51) Int. Cl. G06F 7/04; H04L 9/32

(52) U.S. Cl. 340/5.2; 713/168

(57) ABSTRACT

A method of receiving secure information from a mobile communication device to control an authorisation device in a security system, the method including the steps of the authorisation device: receiving an electronic key transmitted by the mobile communication device; decoding the key using a decoding technique to retrieve a hidden token; and decrypting the retrieved token to retrieve the secure information.

### FIELD OF THE INVENTION

The present invention relates to a security system. In particular, it relates to a method of receiving secure information from a mobile communication device to control an authorisation device in a security system, an authorisation device, a management system and a data structure.

### BACKGROUND

Traditional mechanical lock systems are a well known mechanism for securing access to certain areas. It is usual for such systems to be unlocked by the use of a mechanical key. The mechanical key is inserted into the lock and used to operate on the mechanical elements within the lock to allow access. One drawback with this type of lock system is that the key can become lost which results in the need to replace the entire lock system. A further drawback is that the key itself can fall into the hands of other persons who are then able to gain access using the key. Further, the lock itself is easily accessed through the key hole, and so can be ‘picked’ or ‘bumped’ by a person skilled in that area.

In order to overcome some of the drawbacks of mechanical lock systems, electronic physical security systems were devised. They not only provide improved security but also support a larger set of security functions than traditional mechanical lock systems. By using an electronic lock system, a keyhole is no longer required thus reducing the chances of having the lock picked.

In a basic electronic locking system, the mechanical key of the mechanical lock system is replaced with a storage device, such as an optical or magnetic card, which stores an electronic token. Such a system is described in U.S. Pat. No. 4,534,194. However, while such a system provides a typically lower cost replacement for a mechanical key system, it does not provide any significant increase in security or operational ease of management. For example, if the card were obtained by another person, then that person is able to gain access via the security system. It is also known to extend the type of system described in this patent by including a wireless token delivery system, such as those used in domestic garage door openers.

One advance over the basic electronic lock is the system described in U.S. Pat. No. 6,622,912. In the system described, the key, which may be a magnetic card, wireless transmitter or other such device, contains both authorised user identity information and access rights information for the user. The information stored in the key is protected by an encryption algorithm. The lock stores information related to its own identity as well as access rights for each user. The system allows access rights for a user to be updated whenever the lock is accessed. However, the system is reliant on a physical medium which is unique to the locking system for the key. Such keys need to be programmed at a central site and distributed to authorised users. Also, someone must personally visit each lock to program any new identities when additional users are added to the system.

A further advance is disclosed in U.S. Pat. No. 6,975,202, which describes a system of wirelessly operated electronic locks where the key token is contained in the memory of a portable wireless communication device. The solution may eliminate the need for costly creation and physical distribution of the key media. However, the patent describes a system which requires the locks and wireless communication device to be in contact with a management computer to facilitate the most secure implementation of the system. Furthermore the wireless communication device requires unique software to manage the reception of the key information from the key management facility and to be able to deliver the key to the lock.

In US patent application 2007/0200665, a system is described that unlocks an entry point by forwarding a code to a listed mobile communication device. If a mobile communication device in close proximity to the entry point has permission to gain access to that entry point, a code is forwarded to that mobile device. The mobile device then uses the mobile telephone network to transmit the code to the central control system, which unlocks the entry point. The code itself is not stored on the mobile communication device but instead the code is released for use when an authorised device is detected. In certain circumstances, the code may be obtained by other persons in close proximity to the entry point. Also, it is necessary for the mobile communication device to access the mobile telephone network in order to transmit the code to the central control system, which may prove problematic in some environments.

The present invention aims to overcome, or at least alleviate, some or all of the afore-mentioned problems, or to at least provide the public with a useful choice.

### SUMMARY OF THE INVENTION

In one aspect, the present invention provides a method of receiving secure information from a mobile communication device to control an authorisation device in a security system, the method including the steps of the authorisation device: receiving an electronic key transmitted by the mobile communication device; decoding the key using a decoding technique to retrieve a hidden token; and decrypting the retrieved token to retrieve the secure information.

In a further aspect, the present invention provides an authorisation device in a security system, the authorisation device including a communication interface arranged to receive secure information from a mobile communication device, wherein the secure information is used to control the authorisation device, the authorisation device arranged to receive an electronic key via the communication interface; decode the key using a decoding technique to retrieve a hidden token; and decrypt the retrieved token to retrieve the secure information.

In yet a further aspect, the present invention provides a method of creating an electronic key for controlling an authorisation device in a security system including the steps of: encrypting secure information to form an electronic token using an encryption key, wherein the encryption key includes identification information for a mobile communication device intended to transfer the secure information to the authorisation device, and encoding the electronic token to hide the token within the electronic key.

In yet a further aspect, the present invention provides a key management system for creating an electronic key for controlling an authorisation device in a security system, the key management system arranged to: encrypt secure information to form an electronic token using an encryption key, wherein the encryption key includes identification information for a mobile communication device intended to transfer the secure information to the authorisation device, and encode the electronic token to hide the token within the electronic key.

In yet a further aspect, the present invention provides a data structure for controlling an authorisation device in a security system, the data structure including an encoded electronic token, the token having been encoded to be hidden in the key, wherein the electronic token includes encrypted secure information, wherein the secure information is encrypted using identification information for a mobile communication device intended to transfer the secure information to the authorisation device.

### BRIEF DESCRIPTION OF THE DRAWINGS

Embodiments of the present invention will now be described, by way of example only, with reference to the accompanying drawings, in which:

FIG. 1 shows a schematic diagram of a system according to an embodiment of the present invention;

FIG. 2 shows an authorisation device used in accordance with an embodiment of the present invention;

FIG. 3 shows an access key in accordance with an embodiment of the present invention;

FIG. 4 shows a flow diagram showing how an ad-hoc connection is established in accordance with an embodiment of the present invention;

FIG. 5 shows a flow diagram showing how a paired connection is established in accordance with an embodiment of the present invention;

FIG. 6 shows a flow diagram of a management algorithm in accordance with an embodiment of the present invention;

FIG. 7 shows a block diagram of the key management system according to an embodiment of the present invention.

### DETAILED DESCRIPTION OF THE INVENTION

### First Embodiment

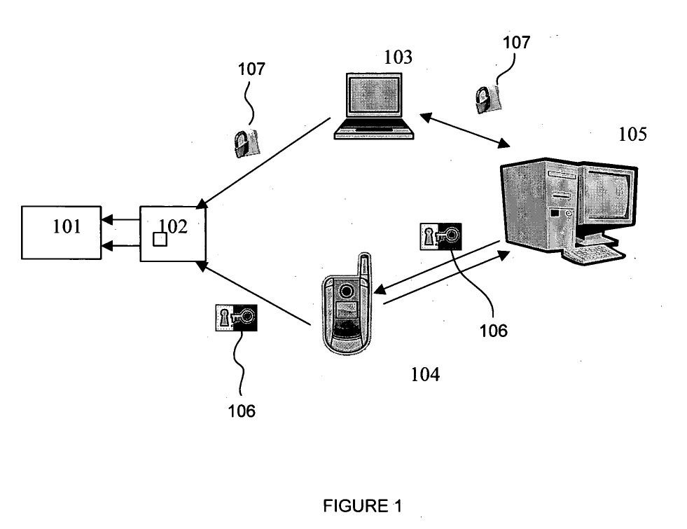

FIG. 1 shows a schematic diagram of a system arranged to implement this embodiment of the invention.

The system includes a security system 101, which is connected to an authorisation device 102. Also forming part of the system is an administration device 103, which may be a portable computing device, such as a laptop or personal digital assistant (PDA), for example. As an alternative, other forms of administration device 103 are envisaged that provide similar functionality. The system also includes a user device 104, which is a portable communication device such as a mobile telephone or PDA. A key management system 105 is also provided, which may be in the form of a computing system with storage means and a communication interface, as will be explained in more detail below.

The security system may be merely a lock that is caused to operate upon a signal from the authorisation device. Alternatively, the security system may be more complex and may consist of any number of locking modules, alarm systems and access systems that are known in the art.

The key management system 105 creates or generates access keys 106, which are sent to the user device 104. The user device 104 in turn forwards the access key 106 to the authorisation device 102 to unlock the security system 101, as will be explained in more detail below.

The key management system 105 also generates management keys 107, which are forwarded to the administration device 103. The administration device 103 then forwards the management key 107 to the authorisation device 102 in order to perform administrative functions, as will be explained in more detail below.

Any number of authorisation devices 102 may be used to control various locks or secure areas to allow authorised persons to enter these areas. Each authorisation device 102 can be separately controlled in order to only allow certain people within the secure areas. Further, authorisation devices 102 may be grouped to allow individuals access to any of the areas controlled by any of the authorisation devices 102 within the group using the same access key 106.

In this embodiment, the interface between the security system 101 and the authorisation device 102 is an analogue security system interface (SSI).

The interface is used with a simple electrically activated lock to form the security system. The interface relies on a voltage level change or a relay contact to be made in order to activate the lock. Alternatively, other known forms of lock activation are envisaged.

As an alternative to the analogue interface, a digital interface can be used to provide a more complex and robust system. The digital interface may be a Wiegand interface or other serial digital link. In the case of a digital interface the authorisation device 102 may pass a pre programmed digital identity or a user specific digital identity (such as a Wiegand number) which forms part of the access key 106 to the security system 101 for additional authorisation.

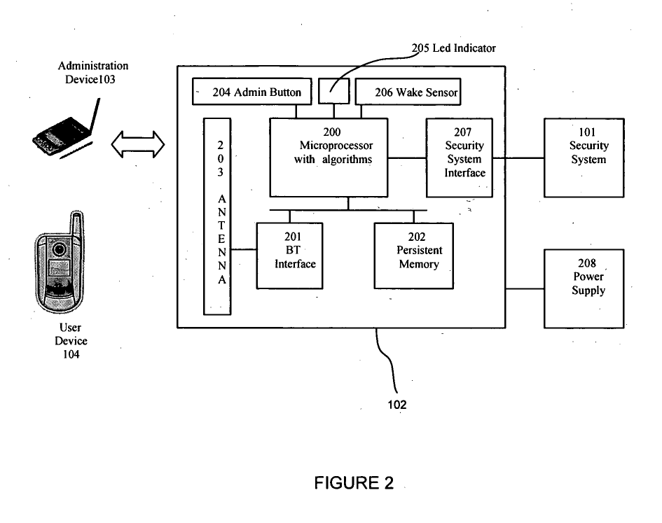

Referring to FIG. 2, the authorisation, device 102 will now be explained in more detail. The authorisation device 102 includes a microprocessor 200, a Bluetooth interface 201, a memory device 202, an antenna 203, an administration button 204, an LED indicator 205, a wake sensor 206 and the SSI 207 to communicate with the security system 101.

The microprocessor 200 is arranged to run a number of algorithms that are stored within the memory device 202, as will be explained in more detail below. In this embodiment, the wake sensor 206 and administration button 204 are the same device. However, it will be understood that, as an alternative, they may be separate devices.

The authorisation device 102 is powered by a power supply 208.

In this embodiment, communication between the authorisation device 102 and the user device 104 or administration device 103 is implemented using a Bluetooth link. In this manner, the user device 104 and administration device 103 can communicate with the authorisation device 102 via the antenna 203 and the Bluetooth interface.

Alternatively, other secure communication protocols other than just Bluetooth may be used without changing the nature of the system. For example, the connection may be implemented using the infra-red IRdA protocol, Bluetooth over IR or other wired or wireless protocols.

Each authorisation device 102 may be configured by receiving one or more parameter files 107, which are delivered by the administration device 103. These parameter files contain any of the following information:
Default encryption key, which, for example, may be used when an access key is not linked to specific user devices;
PIN—Personal Identification Number—to be provided in order to allow a communication link to be established;
Authorisation device Identity;
Authorisation device group Identity;
SSI parameters:
   Analogue—duration of pulse, level of pulse, etc.
   Digital—type, message format (for example site codes and 26, 36, 48, 64 bit Wiegand outputs), etc.
Time and date parameters, for example current date and time, and storing daylight savings dates and changes;
Wake time, i.e. how long the authorisation device 102 stays awake before entering a sleep mode;
Black list user device identities, i.e. a list of devices that will not be allowed to control access to the secure area;
Power management parameters;

The authorisation device 102 may also be configured using the administration button 204 located on the authorisation device 102, as will be explained in more detail below.

The authorisation device 102 maintains a real time clock within the microprocessor that includes the day of week and current date. The real time clock may by in synchronisation with the clock maintained on the administration device 103.

In order to operate the security system 101 to provide access to the secure area, an access, key 106 is delivered by a user device 104 over the Bluetooth link.

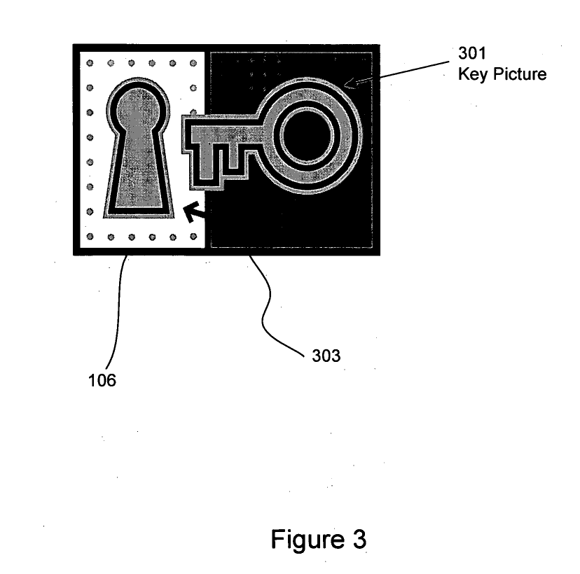

FIG. 3 shows an example of an access key 106 according to this embodiment.

The access key 106 is an electronic file, which, in this embodiment, is composed of two elements. The two elements include an image 301 (in this example, a picture of a key and a lock) and a secure token 303. It will be understood that any suitably sized image may be used, and in cases where extra security is required, it may be more beneficial to use an unassuming random image that does not necessarily indicate to other persons that the image is being used as an access key 106. The access key is generated by the key management system 105 as explained below. In this embodiment, a PIN is required by the authorisation device 102 in order to process the access key 106. The PIN may be requested as part of the communication set up procedure or at any other stage of the decoding and decryption process.

As an alternative to this embodiment, a visible indication of the key owner's access rights may also be incorporated into the image. For example, the image 301 being used may be visibly edited with the access rights information for the user. That is, the user's name, valid secure areas that can be accessed and times of access, for example, may be visibly inserted into the image so that they can be easily read. This enables the user to easily check the access rights that have been granted to them. Further, the fact that the access rights are formed as part of the image does not enable the user to modify their access rights, as the access rights are encrypted, and encoded within the image, as explained below.

The image 301 is compressed to a suitable sized file using the JPEG format.

When the key management system creates the access key 106, the access rights associated with the user device 104 are encrypted using the Bluetooth address of the user device 104 as the encryption key. The Bluetooth address of the user device 104 had previously been obtained by the key management system. The encrypted access rights are referred to herein as a secure token. By using the Bluetooth address of the user device 104 as the encryption key, the secure token is linked to the actual user device which will be used to gain access to the secure area that is controlled by the security system 101.

As an alternative embodiment, a default key may be used as the encryption key thus not linking the user device to any specific access key. For example, the access keys may only have a limited lifetime, for example one day, in which to be used, and thereafter their use would not enable the authorisation device to allow access to the secure area.

The next step involves the key management system encoding the secure token within the JPEG image file. The encoding step is carried out using a steganographic technique. Any suitable steganographic technique may be used. For example, the technique may be accomplished by modifying some of the least significant bits (LSB) in the Discrete Cosine Transform (DCT) coefficients used to form the JPEG image. The LSBs are selected algorithmically so that the encoded data creates minimal impact on the displayed image so as not to reveal that a token is hidden in the image while enabling the secure token to be readily decoded.

In the embodiment where the access rights are not visible on the image, the use of steganography to hide the secure token means that, even if the user device 104 falls into the wrong hands, the person holding the user device 104 will not necessarily know that the user device 104 holds an access key 106. Even if the person did become aware, or knew previously, that the user device 104 does hold an access key 106 they would not necessarily know which image on the user device 104 is the access key 106 and so holds the secure token. Further, they would not necessarily know which authorisation devices 102 the access key 106 can control in order to access the secure area.

The use of steganography to incorporate or encode the encrypted access rights into an image means that it is difficult for a user to amend their own access rights. In addition, the use of PIN to transfer the access key 106 to the authorisation device 102 prevents someone else other than the authorised user using the user device 104.

The size of the JPEG image is selected such that the inclusion of the secure token in the image will not significantly increase the size of the file. As relatively little data is required in the secure token the resulting image file is small enough to be handled by a user device 104 such as a cell phone.

There are many other ways of creating access keys 106. For example, the secure token may be hidden within the JPEG Image Description Field (EXIDF) associated with a JPEG electronic file. However this may be less suitable that the steganographic encoding, as the EXIDF can be easily changed.

Another alternative approach for creating the access key is to use the portable business card format (vCARD) to hide the token. With this approach the secure token may be stored in either of the available binary fields within the electronic file. Also, an appropriate field may be selected for the visible information, if used.

Prior to delivery of the access key 106, a Bluetooth connection with the authorisation device 102 is created.

In order to reduce the power consumption of the authorisation device 102 and extend battery life, the authorisation device 102 is arranged to be in a low power state, or in Bluetooth terms ‘discoverable’, until it is needed. To further reduce power consumption, for example, if the secure area is not going to be accessed for a set period of time, such as national holidays, the authorisation device 102 may be put into deep sleep (or in Bluetooth terms ‘undiscoverable’).

The wake sensor 205 is external to the secured area and is located in a position whereupon a person coming into proximity of the authorisation device 102 can activate it.

The wake sensor in this embodiment is a button positioned near the authorisation device 102 or positioned near the door which the person is attempting to enter. This button also acts as the administration button 20. Upon pressing the button, the authorisation device 102 is woken up if it is in a sleep mode.

Alternatively, the wake sensor 205 may be pressure pad that is located on the floor of an area where the authorisation device 102 is located. Alternatively, an infra-red beam or proximity sensor may be connected to the authorisation device 102 in order to cause the authorisation device 102 to wake up and activate the Bluetooth interface 201.

The connection between the user device 104 and the authorisation device 102 is accomplished at the general access profile level of the Bluetooth stack using standard features available to all Bluetooth devices. There are two different types of connection that may be used using the Bluetooth protocols. The connection may be either a paired or ad-hoc connection. A paired connection provides an additional level of security as a PIN (Personal Identification Number) is required to establish and maintain the Bluetooth connection thus providing a further level of authentication.

The option to use a paired or ad-hoc connection is controlled by configuring the authorisation device.

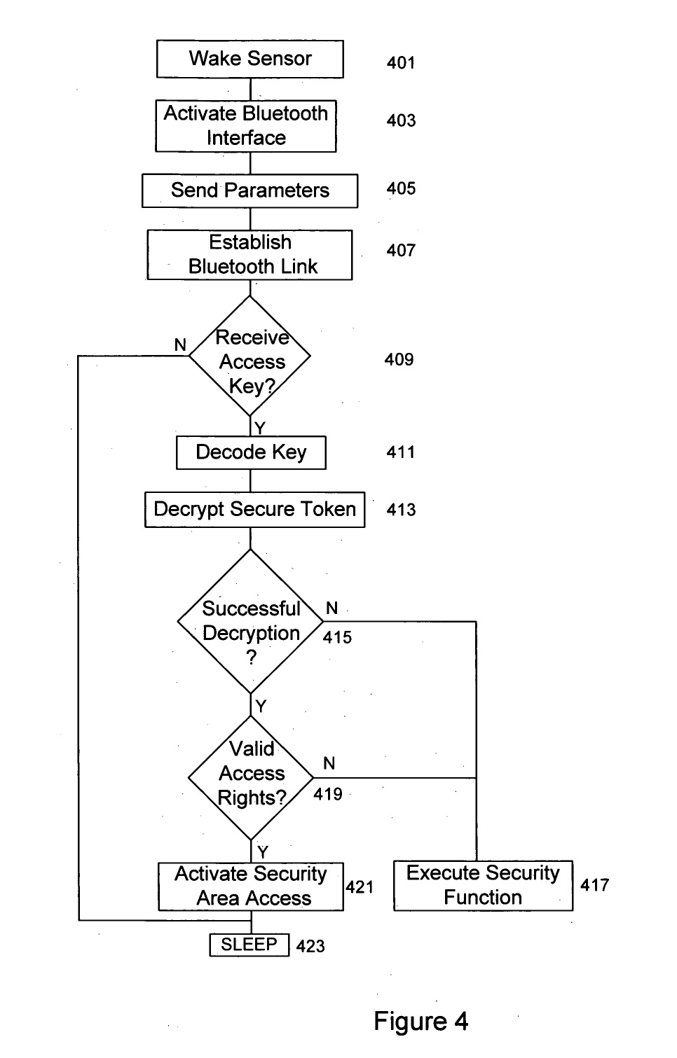

Referring to FIG. 4, a flow diagram showing how an ad-hoc connection is established is shown.

Once the wake sensor of the authorisation device 102 has been activated at step 401, the Bluetooth interface in the authorisation device 102 is activated at step 403.

The user device 104 is then able to discover the Bluetooth interface of the authorisation device 102 and establish a Bluetooth link at, step 407 without the need for a PIN.

Once the Bluetooth interface has been discovered, certain parameters are provided to the authorisation device 102 from the user device 104, such as the name of the user device 104 and Bluetooth address of the user device 104, as shown in step 405.

When the authorisation device 102 is ready to receive an access key, the indicator light 205 is flashed.

The user then sends the access key 106 from the user device 104 to the authorisation device 102 over the Bluetooth connection using Bluetooth protocols, as are well known in the art. The access key is delivered to the authorisation device by the user device 104 selecting the appropriate picture from an images list and sending it over the Bluetooth connection. In this embodiment, the image is sent using the Bluetooth OPP profile. However, it will be understood that the authorisation device 102 may support other common Bluetooth file transfer protocols to allow a large number of user devices 104 to obtain access if they have the appropriate access key 106.

If no access key is received by the authorisation device 102 within a preset time period, the authorisation device 102 returns to sleep mode, as shown in step 423.

Once the access key 106 is received at the authorisation device 102 at step 409, the authorisation device decodes the access key 106, at step 411, using the code that was applied to the picture to steganographically incorporate the secure token 303 within the image.

The secure token 303 is then decrypted, at step 413, using the Bluetooth address of the user device 104. The decryption of the secure token 303 provides the access rights of the user. The encryption and decryption algorithms for the secure token follow the DES (Data Encryption Standard) with the key being the Bluetooth address of the user device 104.

In an alternative embodiment, the secure token may be encrypted using a default encryption key as discussed above.

The authorisation device 102 checks to see if the decryption of the secure token is successful at step 415, i.e. if the authorisation device 102 can read the access rights from the decrypted secure token then the decryption is considered successful, otherwise, it is not. If the access rights can not be read, or there is missing information, then a security function is executed at step 417, as will be explained in more detail below.

If the access rights can be read by the authorisation device 102, the access rights are compared with the current time, day and authorisation device identity or group identity within the authorisation device 102 in order to validate the access rights, as shown in step 419. Further, the user device identification information is used to determine if the user device 104 is on a black list of such devices. The black list is created to ensure that any known missing user devices 104 are not allowed access. Further, the black list can be used to add user devices 104 that have been previously used to try and access the secure areas unsuccessfully after a certain number of attempts. Requests from a user device 104 that is on a black list may be ignored. Alternatively, the authorisation device may initiate an external interface that allows an alarm to be raised when an attempt is made to gain unauthorised access using a black listed device.

If the decrypted access rights match the information and current time and/or date within the authorisation device 102, the security system 101 is activated and the user device 104 is allowed access to the secure area by unlocking the lock associated with the authorisation device 102, as shown in step 421. However, if the access rights do not match, then the security function is executed at step 417. The authorisation device 102 then returns to sleep mode at step 423.

The security function at step 417 may be activated when any of the following events occurs: the received file does not contain a secure token; the secure token cannot be decrypted with the available information; the access rights are invalid for the current time, date, day of week, or authorisation device. The security function can take many forms such as activation of an alarm, disabling the security system for a defined period, writing the user device 104 identity to the black list, as well as other security system functions that will be readily apparent.

The authorisation device 102 logs to the memory device all access attempts, whether successful or unsuccessful.

The user device 104 in the form of a cell phone requires no special modification in order to either receive or deliver the access key, while the access key itself may be locked to the user device and so, while it may be transferred to another device, cannot be used by that other device.

The following is an alternative configuration for establishing a Bluetooth link using a PIN. The authorisation device 102 may be configured to connect to a user device 104 or administration device 103 through a paired Bluetooth connection. A paired connection requires exchange of a secure identity, typically a PIN. A paired connection may be used for accessing administrative functions on the authorisation device by the administration device 103. Where increased security is required, a paired connection may also be used, as the connection protocol between a user device 104 and an authorisation device 102 to gain access to the secure area controlled by the security system. The requirement to input a PIN ensures that the user device or administration device 103 is not only authorised but is also in the possession of an authorised individual.

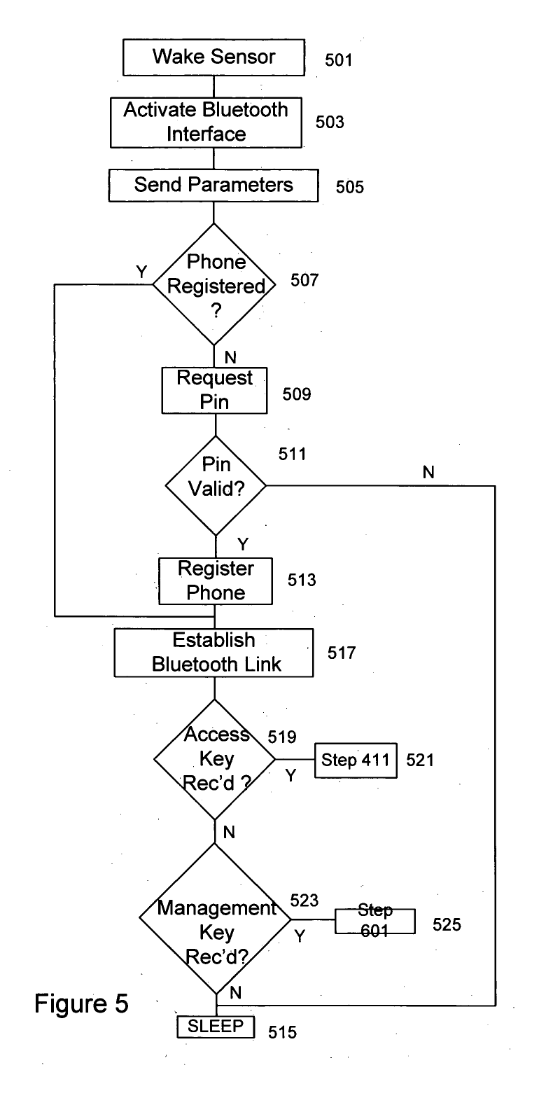

FIG. 5 shows a flow diagram showing how a paired connection is established.

When the wake sensor of the authorisation device 102 has been activated at step 501, the Bluetooth interface is activated at step 503.

Once the Bluetooth interface has been activated, certain parameters are provided to the authorisation device 102 from the user device 104, such as the name and Bluetooth address of the user device 104, as shown in step 505.

At step 507, the authorisation device 102 determines if the user device 104 is registered with it. If the user device 104 is not registered with the authorisation device 102, a PIN is requested from the user device 104 at step 509. If the PIN is determined not to be valid at step 511, the authorisation device 102 returns to sleep mode at step 515. Further, the user device 104 may also be placed on the black list.

If the PIN is determined to be valid at step 511, the user device 104 is registered at step 513.

If at step 507 it is determined that the user device 104 is already registered, the authorisation device 102 establishes the Bluetooth link at step 517.

As an alternative, a request for a PIN may be made prior to establishing the Bluetooth link every time that a user device 104 connects to the authorisation device 102, regardless of whether the user device 104 is already registered or not. This provides an additional level of security ensuring that the user is in fact authorised as well as the user device 104.

After the Bluetooth link has been established, the authorisation device 102 determines if an access key 106 has been received at step 519. If it has, the method moves on to step 411 of FIG. 4 where the key is decoded, and the secure token decrypted to obtain the access rights and determine if the user should be allowed to gain access to the secure area.

If the authorisation device 102 determines that no access key 106 has been received, it then determines if a management key 107 has been received at step 523. A paired connection is required to transmit a management key 107

If no management key 107 has been received, the method follows on to step 515 and the authorisation device 102 returns to sleep mode.

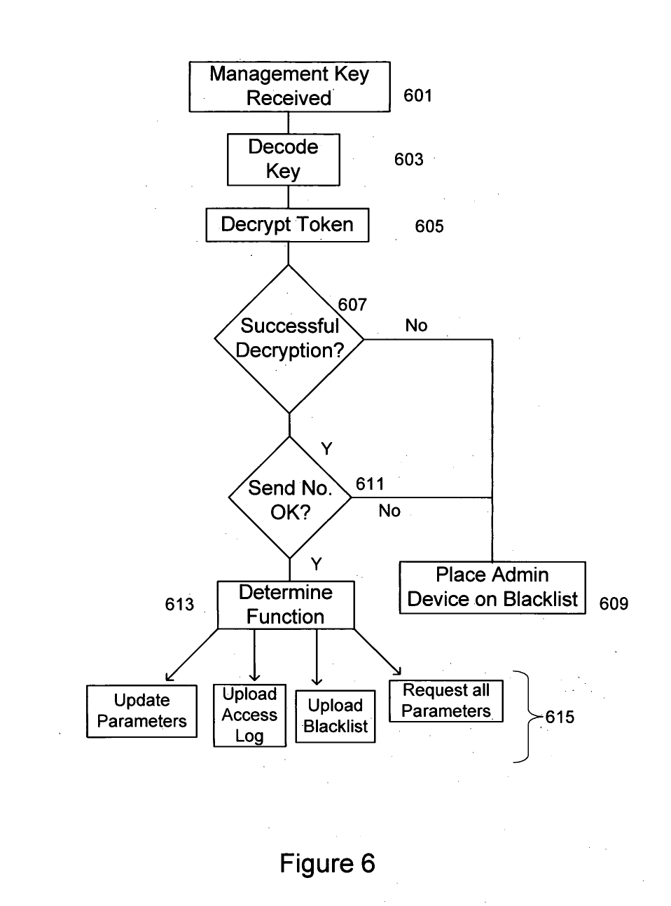

If it is determined by the authorisation device 102 that a management key 107 rather than an access key 106 has been received, the method moves to step 601, as described below in relation to FIG. 6.

It can be seen that, in the case of an ad-hoc link only an access key 106 may be received by the authorisation device 102, whereas with a paired connection either an access key 106 or a management key 107 may be received.

A number of management functions are available to control the authorisation device 102. These functions may be accessed by either sending a management key 107 over the Bluetooth connection from an administration device 103 or by pressing the administration button 204. Some functions are only accessible when the management key 107 is sent, whereas some common functions may be accessed using the administration button 204.

A Bluetooth connection is established between the authorisation device 102 and the administration device 103 using the secure paired connection method as described above.

Management keys 107 are similar to access keys 106, wherein they have an image with a management secure token steganographically encoded in the image in a similar manner as the secure token is encoded in the access key 106 described above. The management secure token as with the secure token in the access key 106 is encrypted using the administration device Bluetooth identity. The key management system 105 carries out the encoding and encryption steps and forwards the management key 107 to the administration device 103 using standard mobile communication transmission methods, or via e-mail for example. The function that the authorisation device 102 is to perform is stored within the management key 107 in an encrypted form.

Once received by the authorisation device 102, the management secure token is processed according the management algorithm depicted in FIG. 6.

That is, at step 601, the management key 107 is received. At step 603, the management key 107 is decoded to obtain the management secure token. The management secure token is then decrypted at step 605 using the key identified above, which in this embodiment is the Bluetooth identity of the administration device 103.

The administration device 103 determines if the management secure token was successfully decrypted at step 607, and, if not, places the administration device 103 on the blacklist of administration devices at step 609. This ensures that any administration device on the black list no longer receives further management keys 107 and is denied access to the authorisation device 102.

If the management secure token is successfully decrypted at step 607, the administration device 103 checks the serial number of the token. The key management system 105 creates management secure tokens in a sequential order with specific sequential serial numbers. As the administration device 103 processes the tokens, the serial number sequence is checked to see if the token is valid. If not, the administration device 103 is placed on the blacklist at step 609. Further, receipt of an invalid token may be used to activate a security function as described above. In most cases however, the security function adds the administration device 103 to a blacklist which results in the authorisation device 102 no longer accepting a trusted paired connection from the blacklisted administration device 103 until the blacklist is cleared by an authorised administration device 103.

If the token is valid, the administration device 103 determines at step 613 what function it is required to perform based on the form of the token and carries out the function at step 615. For example, the management secure token may simply include a number that relates to a particular function, or may be a more complex series of instructions for the administration device 103 to implement. The functions may be any type of function associated with the administration device 103, and may include, for example, updating parameters, uploading access logs, uploading the black list, resetting all parameters etc.

In the case where the administration device 103 is replacing the parameter file of an authorisation device 102 either a single file may be used or a separate file per information type. The use of separate files increases the security of the system by only allowing parts of the information to be changed.

Other management functions that are available include but are not limited to clearing the paired phone list or clearing the blacklist, for example.

Many other administration functions may be added to the system to either improve security or provide additional functionality.

In addition to performing administrative functions using the management key 107, the administration button 204 on the authorisation device 102 may also be used to carry out some of functions discussed above.

The authorisation device 102 is arranged to detect the number of times the administration button 204 is pressed within a preset time limit and then perform a certain function depending on that number. For example, the functions may be selected by pressing the button twice to load a parameter file, three times to request the log file etc. Holding the button down for a period of at least one second instructs the authorisation device 102 that the function selection is confirmed. The selection is acknowledged by the indicator light flashing the appropriate number of times.

The Key Management System provides the central control of a series of authorisation devices 102 and is used to create and transmit access keys and management keys. The management of the authorisation devices 102 and distribution of access keys 106 and management keys 107 is accomplished without a direct connection to either the authorisation device 102 or user device 104. Instead, the cell phone network or internet may be used to distribute the access keys 106 or management keys 107 for either gaining access to the secure areas or managing the authorisation devices 102.

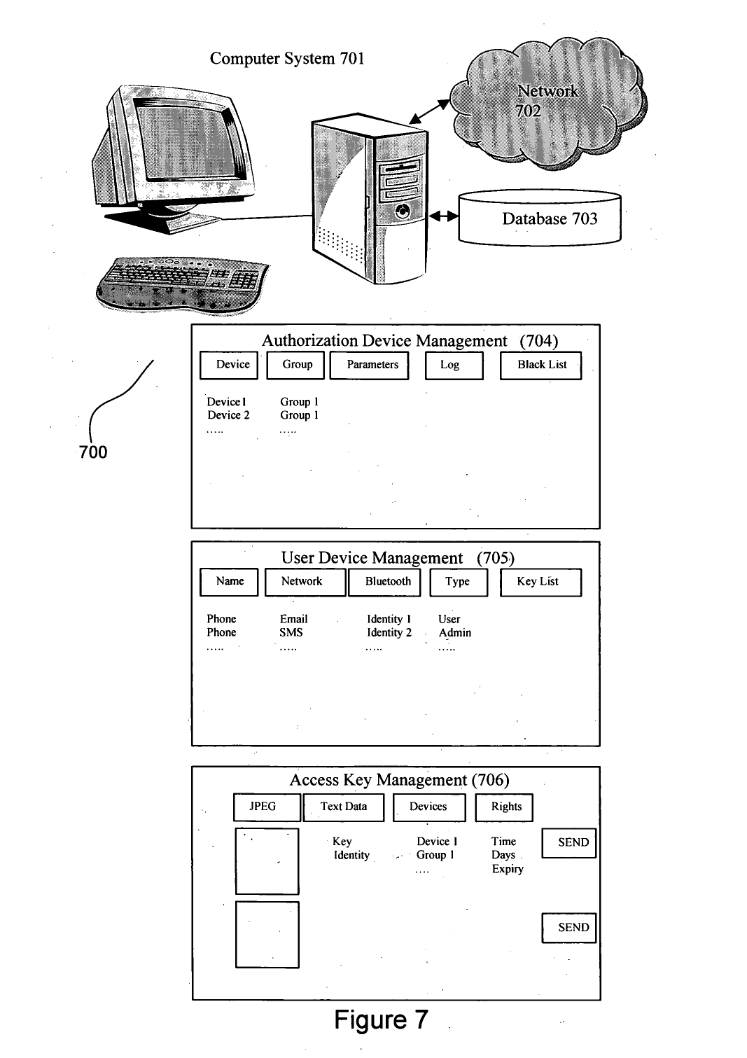

FIG. 7 shows a block diagram of the key management system.

The key management system 700 includes a computer system 701 with a visual display unit and input and output interfaces, such as a keyboard, mouse and communication ports. The computer system 701 is connected to a network 702, such as the Internet or a mobile communication network, such as the GSM network. The computer system 701 is also connected to a database 703 in which data associated with each authorisation device 102, user device 104, administration device 103, access key 106, management key 107 and their associated tokens is stored.

A management application runs on the computer system 701 allowing an operator to modify data in the database, send data to and receive data from user devices 104 and administration devices 103 through the network. Data may be sent and received via email or mobile telephone picture messages with access keys 106 and management keys 107 being sent in the form of attachments, for example. However, it will be understood that other methods, such as File Transfer Protocol (FTP), may be used as an alternative.

The computer system 701 provides access to the database through a graphical user interface (GUI) which is displayed on the display unit.

Examples of screens displayed on the GUI are included in FIG. 7. The first screen 704 is an authorisation device management screen. The second screen 705 is a user device management screen. The third screen 706 is a key management screen.

Through the authorisation device management screen 704, a list of authorisation devices currently known to the system is accessed. The authorisation devices may be added deleted or modified through on screen manipulation. An authorisation device is known by its Bluetooth address. Alternatively, authorisation devices may be named for simplicity of operation. Authorisation devices with identical characteristics may be assigned to groups for ease of management. A parameters field displays current core parameters. These parameters may be displayed in more detail on a further screen, to be manipulated.

The authorisation device management screen also allows log files and black list files uploaded from administration devices to be reviewed, and, in the case of black list files, manipulated or modified.

The second screen is the user device management screen 705. From this screen both user devices and administration devices may be managed. The critical device parameters such as Bluetooth address and name, which are required for generating access keys and management keys may be entered and edited. New user devices and administration devices may be either entered manually or, if the device is locally available, discovered over a Bluetooth interface incorporated into the key management system. This second screen provides access to the key management screen 705.

Further, an access key management screen 706 may be accessed through the key list field shown on the user device management screen 705.

The access key management screen 706 provides the operator with the ability to select key images, edit key user readable descriptions (if used) and access rights. The authorisation device and authorisation device groups to which the access rights pertain may be selected from an automatically generated pick list, wherein the operator selects the appropriate option. Once the access key information is complete, the operator selects the SEND key to send the access key to the user device. When the SEND key has been selected, the access rights are encrypted to form the secure token, followed by the encoding of the secure token into the key image. The resulting access key is sent via email or other selected delivery means to the network address associated with the user device.

Management keys are generated in a similar way to the access keys and sent to the relevant administration devices. A management key management screen enables the different functions of the authorisation device to be entered into the management key via the encrypted management secure token.

### Further Embodiments

It will be understood that the embodiments of the present invention described herein are by way of example only, and that various changes and modifications may be made without departing from the scope of invention.

While the Security System describe above can be used to secure an area by controlling access via a lock or door, it will be understood that the access key may be used for other purposes. For example an electronic ticket may be developed for a public transport system, such as a monthly pass. Here the access key has a period of validity for the key, while the authorisation device group would be those forms of public transport for which the key is valid, for example, buses or trains, or both. An off-peak or any time ticket may be established by changing the access rights in the access key.

As another example, the access key can be used as a ticket to enable access to an event, such as a concert for example. The use of a ticket keyed to the purchaser's personal cell phone helps prevent the resale of the ticket on an on line auction site which can be a problem with many current event ticketing means. By using a digital interface with the security system, the access key can be identified by the security system when received at the event thus preventing multiple usages. Alternatively a “pass-out” could be contrived at an exit point from the arena by sending the key either back to the user device or changing access rights so that another authorisation device may be used to enter the event.

As a further alternative, access rights may be further verified at the authorisation device as well as checking that the correct time, date and authorisation device accessed match the rights received. For example, the access rights received from the user device may be confirmed against a stored version of the access rights in the authorisation device.

It will be understood that various different types of connections may be made to connect and transfer data between the authorisation device and the user device. For example, the connections may be a wireless connection, a wired connection, a Bluetooth connection, an infra-red connection, a Wi-fi connection, a near field communication (NFC) connection, a Zigbee connection, or a combination thereof.

1.-59. (canceled)

60. A method of retrieving secure information from a mobile communication device to control an authorisation device in a security system, the method including the steps of the authorisation device:
receiving an electronic key transmitted by the mobile communication device;
decoding the key using a decoding technique to retrieve a hidden token, wherein the token is hidden in an unencrypted image using a steganographic technique; and
decrypting the retrieved token to retrieve the secure information by receiving identification information from the mobile communication device that identifies the mobile communication device, and decrypting the token using the identification information.

61. The method of claim 60 further including the steps of requesting and verifying a personal identification number from the mobile communication device prior to receiving the electronic key.

62. The method of claim 60 wherein the secure information includes access rights information for controlling an entry point in the security system, the method further including the steps of the authorisation device:
retrieving the access rights information from the secure information;
determining if the retrieved access rights information is valid, and
providing access to the entry point upon a positive determination.

63. The method of claim 62, wherein the step of determining if the access rights information is valid includes the steps of:
determining the current time, day or date,
detecting the time, day or date associated with the retrieved access rights information,
determining if the time, day or date of the retrieved access rights information complies with the current time, day or date, and, upon a positive determination, validating the retrieved access rights information.

64. The method of claim 63 whereupon a negative compliance determination the method further includes the step of placing the mobile communication device on a list of invalid devices and/or outputting an alarm.

65. The method of claim 63, wherein the step of determining if the access rights information is valid includes the steps of determining if the retrieved access rights information is the same as stored access rights associated with the mobile communication device, and, upon a positive determination, validating the retrieved access rights information.

66. The method of claim 60 wherein the secure information includes function information for controlling functions of the authorisation device, the method further including the steps of the authorisation device:
retrieving the function information from the secure information;
determining the function associated with the function information, and
executing the function on the authorisation device.

67. The method of claim 66, wherein the secure information includes a serial number and the method further includes the steps of
reading the serial number,
determining if the serial number read is the next in sequence, and, upon a positive determination,
executing the function.

68. An authorisation device in a security system, the authorisation device including a communication interface arranged to retrieve secure information from a mobile communication device, wherein the secure information is used to control the authorisation device, the authorisation device arranged to receive an electronic key via the communication interface;
decode the key using a decoding technique to retrieve a hidden token wherein the token is decoded from an unencrypted image using a steganographic technique; and decrypt the retrieved token to retrieve the secure information by being further arranged to receive identification information from the mobile communication device that identifies the mobile communication device, and
decrypt the secure information using the identification information.

69. The authorisation device of claim 68 further arranged to request and verify a personal identification number from the mobile communication device prior to arranging to receive the electronic key.

70. The authorisation device of claim 68 wherein the secure information includes access rights information for controlling the entry point in the security system, the authorisation device further including control means to control access to an entry point in the security system and arranged to:
retrieve the access rights information from the secure information;
determine if the retrieved access rights information is valid, and
control the entry point to provide access upon a positive determination.

71. The authorisation device of claim 70 further arranged to determine if the access rights information is valid by:
determining the current time, day or date,
detecting the time, day or date associated with the retrieved access rights information,
determining if the time, day or date of the retrieved access rights information complies with the current time, day or date, and, upon a positive compliance determination,
validating the retrieved access rights information.

72. The authorisation device of claim 71 whereupon a negative compliance determination the authorisation device is further arranged to place the mobile communication device on a list of invalid devices and/or output an alarm.

73. The authorisation device of claim 70 further arranged to validate the access rights information by determining if the retrieved access rights information is the same as stored access rights associated with the mobile communication device, and, upon a positive determination, validating the retrieved access rights information.

74. The authorisation device of claim 6g wherein the secure information includes function information for controlling functions of the authorisation device, the authorisation device arranged to:
retrieve the function information from the secure information;
determine the function associated with the function information, and
execute the function.

75. The authorisation device of claim 74, wherein the secure information includes a serial number and the authorisation device is further arranged to:
read the serial number,
determine if the serial number read is the next in sequence, and, upon a positive determination,
execute the function.

76. A method of creating an electronic key for controlling an authorisation device in a security system including the steps of:
encrypting secure information to form an electronic token using an encryption key, wherein the encryption key includes identification information for a mobile communication device that identifies the mobile communication device, where the mobile communication device is intended to transfer the secure information to the authorisation device, and
encoding the electronic token to hide the token in an unencrypted image using a steganographic technique within the electronic key.

77. The method of claim 76, wherein the secure information includes access rights information to provide access to an entry point in the security system.

78. The method of claim 76, wherein the secure information includes function information for controlling functions on the authorisation device.

79. The method of claim 78, wherein the secure information further includes a sequential serial number.

80. A key management system for creating an electronic key for controlling an authorisation device in a security system, the key management system arranged to:
encrypt secure information to form an electronic token using an encryption key, wherein the encryption key includes identification information for a mobile communication device that identifies the mobile communication device, where the mobile communication device is intended to transfer the secure information to the authorisation device, and
encode the electronic token to hide the token in an unencrypted image using a steganographic technique within the electronic key.

81. The key management system of claim 80, wherein the secure information includes access rights information to provide access to an entry point in the security system.

82. The key management system of claim 80, wherein the secure information includes function information for controlling functions on the authorisation device.

83. The key management system of claim 82, wherein the secure information further includes a sequential serial number.

84. A data structure for controlling an authorisation device in a security system, the data structure including an encoded electronic token, the token having been encoded to be hidden in an unencrypted image using a steganographic technique, wherein the electronic token includes encrypted secure information, wherein the secure information is encrypted using identification information for identifying a mobile communication device intended to transfer the secure information to the authorisation device.
